(19) United States
(12) Patent Application Publication
(10) Pub. No.: US 2006/0282473 A1
(43) Pub. Date: Dec. 14, 2006

(54) Rules-based data evaluation and process trigger system and method

(76) Inventors: Adam S. Horrocks, Sandy, UT (US); Christopher G. Seaman, South Jordan, UT (US); Mark R. Stiegemeier, Park City, UT (US)

Correspondence Address: MOTOROLA, INC., 1303 EAST ALGONQUIN ROAD, IL01/3RD, SCHAUMBURG, IL, 60196, US

(21) Appl. No.: 11/169,342

(22) Filed: Jun. 29, 2005

Related U.S. Application Data
(60) Provisional application No. 60/688,427, filed on Jun. 8, 2005.

(51) Int. Cl. G06F 17/30

(52) U.S. Cl. 707/200

(57) ABSTRACT

A method for rules-based data evaluation and process trigger executed in a records management system that includes a server computer and at least one client computer, the method including the steps of: receiving (210) a source document having a predetermined format; creating (220) at least one definition for the source document, each definition comprising at least one criterion for evaluating an instance of data corresponding to the source document; receiving (230) a first instance of data corresponding to the source document; evaluating (240) the first instance of data using the at least one definition and determining whether to generate at least one conclusion based on the evaluation, each conclusion indicating that the at least one criteria is met; and determining (250) whether to perform at least one action based on at least one generated conclusion.

### FIELD OF THE INVENTION

The present invention relates generally to records management systems and more specifically to rules-based data evaluation and process trigger in such systems.

### BACKGROUND OF THE INVENTION

Complex information systems need an automated ability to ‘trigger’ or cause processes based on the changing or cumulative nature of data. Document centric systems provide more than a means for storage, retrieval, and deletion of documents. These systems provide analysis and feedback, direct work, allow for notifications, and other basic document or data specific tasks. This functionality frequently is very specific to the system owner and requires unique and specific customization. Because of this specific customization, an intimate knowledge of the underlying application code and the storage architecture would typically be required in order to create data evaluation code and triggers that would enable the above-referenced functionality. Accordingly, in such systems it would be very difficult to automate data processing and evaluation especially when data resides in different data stores and different data structures.

Thus, there exists a need for a data evaluation and process trigger system and method for information systems that is not dependent on and does not require an intimate knowledge of the data store architecture and application code underlying the system. It is further desirable that the system and method is capable of providing analysis and feedback relating to data input into the system even when the data resides in different data stores and data structures.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a block diagram of an exemplary records management system suitable for implementing embodiments of the present invention;

FIG. 2 illustrates a flow diagram of a method for a rules-based data evaluation and process trigger in accordance with embodiments of the present invention;

FIG. 3 illustrates a more detailed flow diagram of a method for rules-based data evaluation and process trigger in accordance with embodiments of the present invention;

FIG. 4 illustrates an exemplary screen shot of a user interface for creating a definition in accordance with embodiments of the present invention;

FIG. 5 illustrates an exemplary screen shot of a user interface for creating a definition in accordance with embodiments of the present invention;

FIG. 6 illustrates an exemplary screen shot of a user interface for creating a definition in accordance with embodiments of the present invention;

FIG. 7 illustrates an exemplary screen shot of a user interface for creating a definition in accordance with embodiments of the present invention;

FIGS. 8A and 8B illustrates a detailed flow diagram of an evaluation engine that may be used in implementing the method illustrated in FIG. 3; and

FIG. 9 illustrates a detailed flow diagram of a monitoring service or engine that may be used in implementing the method illustrated in FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to a rules-based data evaluation and process trigger system and method. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of the rules-based data evaluation and process trigger system and method described herein. The non-processor circuits may include, but are not limited to, a radio receiver, a radio transmitter, signal drivers, clock circuits, power source circuits, and user input devices. As such, these functions may be interpreted as steps of a method to perform the rules-based data evaluation and process trigger system and method described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, a rules-based data evaluation and process trigger system and method is described. In accordance with embodiments of the invention, a user may utilize a user interface of a computer to create a document (or definition), for instance an XML (Extensible Markup Language) document, that enables the evaluation of any type of document (or instance of data) regardless of data store, data structure and data values. Data from multiple sources can be evaluated and understood without creating any data field or code mapping. The XML document created by the user interface may further define what actions should be taken and when those actions should be taken, with respect to an instance of data that has been evaluated. The process of creating the definition does not require any programming, nor does it require an understanding of XML or the data store.

An instance of data (e.g., a completed document) is evaluated by an evaluation engine using one or more definitions, and a conclusion may be generated based on the definition(s) and the instance of data. There can be none, one or multiple conclusions generated for a single instance of data, and each conclusion may be updated as data changes and may correspond to one or more document(s) or a portion thereof.

In embodiments of the present invention, actions are not typically processed by the evaluation engine but by a separate process that monitors the conclusions and determined when an action should be taken. Actions are not taken based on the actual data in the data instances but on the conclusions resulting from evaluating the data in view of the definition(s). The actions may include or be based upon, for example, messaging, a “workflow” engine, and a re-evaluation of one or more conclusions (which essentially allows cascading conclusions). Moreover, the conclusions are updated with the corresponding actions that were determined based on those conclusions.

Those skilled in the art will realize that the above recognized advantages and other advantages described herein are merely exemplary and are not meant to be a complete rendering of all of the advantages of the various embodiments of the present invention.

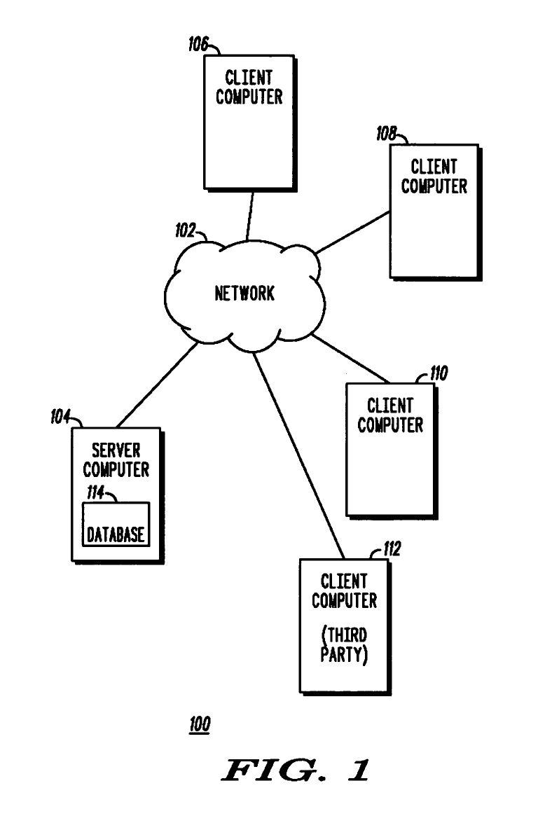

Referring now to the drawings, and in particular FIG. 1, a block diagram of an exemplary records management system suitable for implementing embodiments of the present invention is shown and indicated generally at 100. Those skilled in the art, however, will recognize and appreciate that the specifics of this illustrative example are not specifics of the invention itself and that the teachings set forth herein are applicable in a variety of alternative settings. For example, since the teachings described do not depend on the particular system architecture used, they can be applied to any type of system architecture used although a client/server model is shown in this embodiment. As such, other alternative implementations of using different types of system architectures are contemplated and are within the scope of the various teachings described. Moreover, in the following illustrations, embodiments of the present invention make specific mention of its use in the context of law enforcement. However, those skilled in the art will readily realize that the principles of the present invention described herein are not limited to such an implementation, but that these principles may be applied in other contexts such as in records management for health care, social services, and the like without loss of generality.

System 100 comprises a network 102, which is the medium used to provide communications links between various devices and computers connected together within system 100. Network 102 may include permanent connections, such as wire or fiber optic cables, or temporary connections made through telephone connections or wireless connections, although the particular embodiment of the present invention illustrated herein may include wire and/or wireless connections for transmitting data to and from, for instance, patrol vehicles and crime scenes. Moreover, network 102 may represent the Internet or one or more other types of networks such as, for instance, an intranet, a Local Area Network (LAN), a Wide Area Network (WAN), etc.

System 100 further comprises a server computer 104, client computers 106, 108, 110, 112 coupled to server computer 104 via network 102 and a data base 114 typically coupled to the server computer 104 for storing data in accordance with embodiments of the present invention. Server computer 104 typically includes suitable hardware (e.g., a processor, memory, etc.) as is well known in the art and software (e.g., implemented in the languages C++ and Visual Basic) for implementing embodiments of the present invention. Client computers 106, 108, 110,112 also typically include suitable hardware (e.g. a processor, memory, transceiver, etc.) as is well known in the art and software (e.g., implemented in the languages C++ and Visual Basic) for implementing embodiments of the present invention. Client computers may be, for example, personal computers, personal digital assistants (PDAs), network computers, etc. Moreover, the client computers may comprise one or more computers associated with a given user group (e.g., client computers 106, 108, 110) and one or more computers not so associated (e.g., a third party computer 112). In one embodiment, server computer 104 may provide data, such as boot files, operating system images, and applications to client computers 106, 108, 110, 112, and the client computers may be clients to server computer 104. The database 114 may be any suitable data storage device. System 100 may further comprise additional servers, clients, databases, and other devices not shown or may comprise fewer client computers.

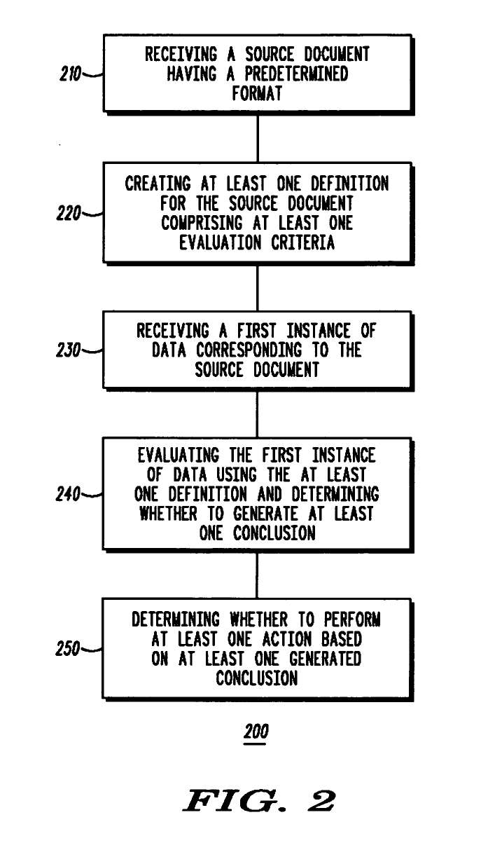

Turning now to FIG. 2 a flow diagram of a method for a rules-based data evaluation and process trigger in accordance with embodiments of the present invention is shown and generally indicated at 200. The steps of method 200 generally comprise: receiving (210) a source document having a predetermined format; creating (220) at least one definition for the source document, each definition comprising at least one criterion for evaluating an instance of data corresponding to the source document; receiving (230) a first instance of data corresponding to the source document; evaluating (240) the first instance of data using the at least one definition and determining whether to generate at least one conclusion based on the evaluation, each conclusion indicating that the at least one criterion is met; and determining (250) whether to perform at least one action based on at least one generated conclusion.

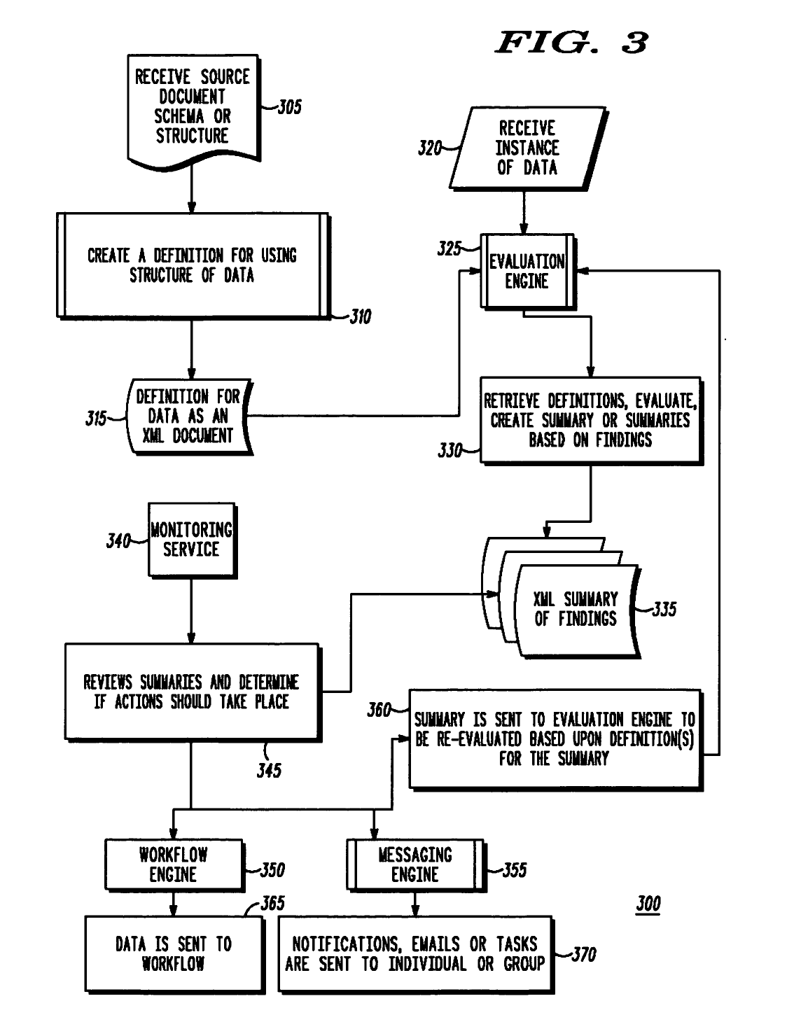

FIG. 3 illustrates a more detailed flow diagram 300 corresponding to the method 200 for rules-based data evaluation and process trigger in accordance with embodiments of the present invention. The method may be performed in the server computer 104. At step 305, a source document may be received into the system, wherein a document comprises structured information and may include, but is not limited to, traditional written documents such as the present application, vector graphics, e-commerce transactions, mathematical equations, object meta-data, server APIs (application program interfaces), etc. Thus, the source document may be any type of document into which data may be captured for later analysis in accordance with embodiments of the present invention. For example, the source document may be an arrest report, a personnel report, etc. Ideally the source document is received in a predetermined format to enable efficient manipulation of the document and to also enable any document to be received into the system regardless of the manner in which the document was created and is stored and regardless of who creates the document.

In one embodiment, the predetermined format is an Extensible Markup Language (or XML) standard, and the source document received is an XML document or more particularly, may be an XML schema or structure corresponding to the data that may be captured into the document. The XML source document may be a document created internal to a given user group or an “internal” document (e.g., internal documents for a local police agency) or external to the user group or an “external” document (e.g., external documents created by the Federal Bureau of Investigation (FBI)). It should be understood by those skilled in the art that the application of the principles of the present invention are not limited to embodiments implementing XML, but embraces other suitable formats, especially those that enable richly structured documents to be shared over a network such as, for instance, the Internet, a WAN, a LAN, etc.

Once received, one or more definitions may be created for or corresponding to the source document, at step 310. Generally the one or more definitions created are specific to and apply only to a given source document. The number of definitions created depends upon how a user desires an instance of data corresponding to the source document to be evaluated. The definition describes and controls how an instance of data corresponding to the source document will be evaluated and, if necessary or appropriate, acted upon. It comprises a set of one or more criterion for evaluating an instance of data corresponding to the source document and may also comprise one or more actions that may be taken upon criteria in the definition being met. Moreover, the definition may comprise additional fields for identifying the definition and associating the definition with the source document for later retrieval when an instance of data corresponding to the source document needs to be analyzed. For example, the definition may comprises a name, a subject, a unique identifier for the source document, an identifier for the group or organization who created or owns the source document and/or the definition, etc.

The criteria may include, simply, identifying that an instance of data corresponding to the source document was received into the system. The criteria may for instance further be defined by or based on, a Boolean expression comprising one or more clauses. The Boolean expression may be in Disjunctive Normal Form. The clauses in the Boolean expression may comprise logical clauses that allow fields to be compared to other fields or user defined values and may be characterized, for example, as a text comparison, a data comparison or a numeric comparison. In one embodiment, junctors are limited to {AND, OR} and are required for each Boolean expression with multiple clauses. The clauses in the Boolean expression may further comprise data state clauses that enable an evaluation of an instance of data corresponding to the source document based on the state of the document's instance. The document state may be, for example, that the document: exists (e.g., is newly created), is being updated, is being printed, is being deleted, is being viewed, is being processed in accordance with a workflow engine, etc.

In addition, as mentioned earlier the definition may comprise one or more actions (e.g., processing instructions) that may be taken upon criteria having been met. For example, messages or tasks can be created, one or more conclusions based on the instance of data can be sent to a workflow process or engine (e.g., that facilitates one or more manual and/or automated actions being taken), and/or the conclusion(s) can be evaluated or re-evaluated based upon a definition or definitions corresponding to the conclusion(s), etc. In addition, when and how often one or more actions are taken can be identified in a definition. This may include, for example, the user inputting that an action may be taken directly upon criteria being met once, or after criteria are met a plurality (at least two) times within a period of time (e.g., by a specific date) or on a rolling time basis (e.g., with a 30 day period). Moreover, each definition created may be an XML document, as in step 315, and may be stored, for instance, in database 114 for later retrieval.

In one embodiment, the one or more definitions may be created using a suitable user interface for guiding a user through the creation of the definition(s) by prompting the user to provide inputs into various fields. The fields may be designed based on a given source document and may further be designed to be adaptive based upon a given response or input from a user. This facilitates embodiments of the present invention wherein creating the definitions do not require any programming (in other words, it does not require intimate knowledge of any underlying programming language) and facilitates embodiments that do not require a user's knowledge of the document structure (e.g., XML) or its data store.

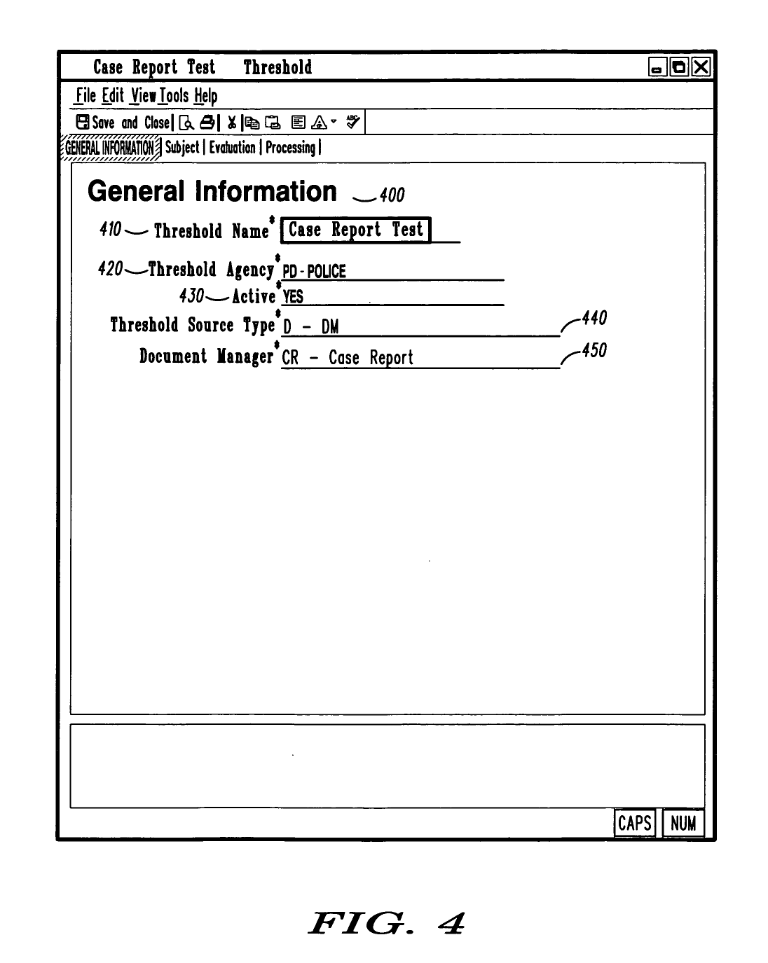

FIGS. 4-7 illustrate various exemplary screen shots for using an exemplary user interface to create a definition in accordance with embodiments of the present invention. In the screen shot shown in FIG. 4, a user may be prompted to enter general information 400 such as: a name of the definition (e.g., Threshold Name—Case Report Test 410); a group or organization that owns the definition (e.g., Threshold Agency—PD-Police 420); whether the definition is being actively monitored for instance by a monitoring engine (e.g., Active—Yes (or No) 430); an identification of the source document's origination (e.g., Threshold Source Type—D-DM (document manager) 440), which may be used to indicate whether it is an “internal” or “external” source document or originates from another definition; and identification of the source document type (e.g., Document Manager—CR Case Report 450). At least a portion of this subject information may be used as criteria to evaluate an instance of data corresponding to the source document.

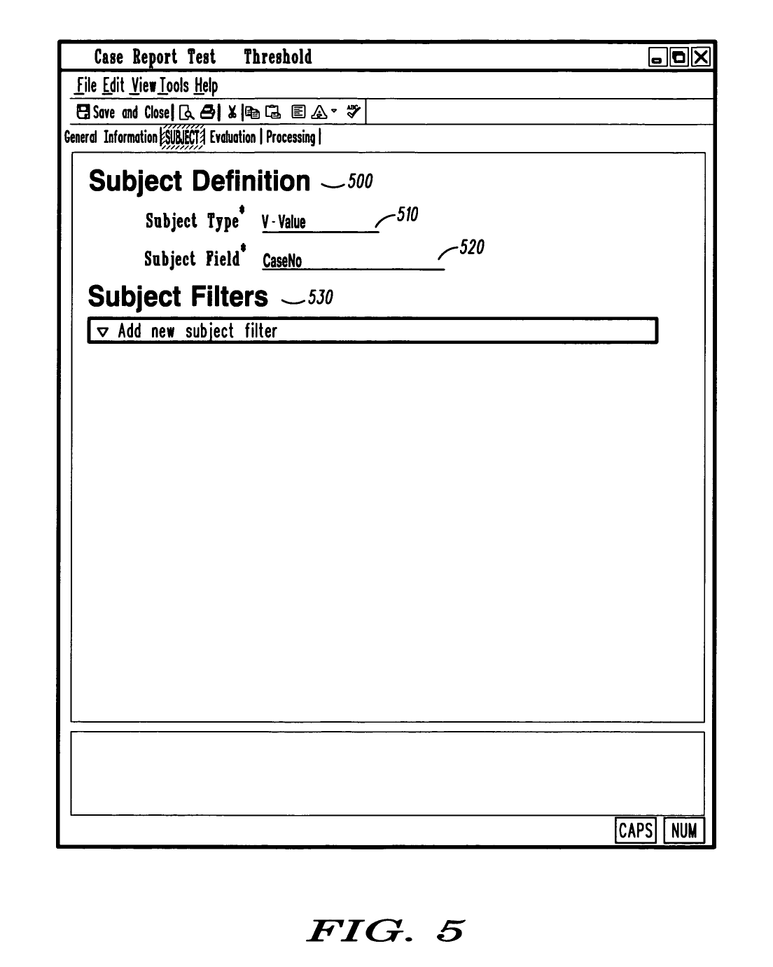

In the screen shot shown in FIG. 5, a user may be prompted to enter subject information 500 for the definition, wherein at least a portion of this subject information may be used as criteria to evaluate an instance bf data corresponding to the source document. The subject information may include, but is not limited to, identifying the name or type of subject that will be evaluated upon receipt of an instance of data (e.g., Subject Type-V-Value 510). In one embodiment a separate definition is generated for each subject name to facilitate clarity in the analysis of data instances and in any resulting conclusions based upon the analysis. The subject name may be, for instance, a field in the source document that will contain the data to be evaluated. Alternatively, the subject name may be a custom value defined by the user (e.g., V—Value), an organization identification (ID) corresponding to a group or organization or a personnel ID, for instance, for a person associated with a group or organization.

In this illustration, once the user selects the subject name or type, the user is further prompted to cause the specific subject name to be captured by the user interface (e.g., Subject Field—Case No. 520). For instance, where the user selects source document field, personnel ID or organization ID as the subject type, the user would then be prompted to, respectively, select a particular field in the source document, personnel ID or organization ID. In one embodiment, the particular source document field, personnel ID or organization ID may be selected using respective drop down menus that ideally are dynamically adaptive based upon the particular source document for which the definition is being created. Where the user selects custom value as the subject type, the user may then be prompted to, for example, enter a corresponding custom value.

As illustrated in FIG. 5, the user may also optionally enter one or more filters 530 for the subject, wherein for instance, the document would only be evaluated if each filter is satisfied. Thus, the filter(s) limit the subjects that may be available for the definition. The filter may in one embodiment comprise custom (e.g., a custom value defined by the user), organization (e.g., an agency or organization within an agency), or personnel (e.g., a unique id for an individual in a local system) limiting instructions input by the user. For example, where the subject is a field in the source document, the subject can be filtered using a current organizational chart or a list (e.g., a drop down menu) of custom values.

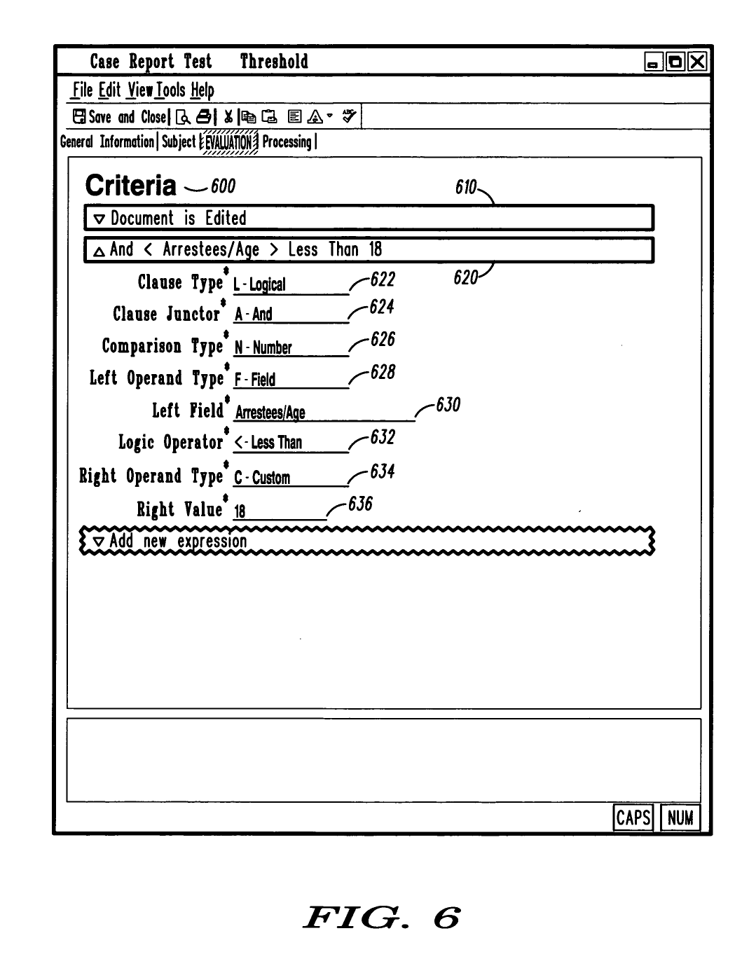

In the screen shot shown in FIG. 6, the user may be prompted to enter additional criteria 600 for evaluating an instance of data corresponding to the source document. These are instructions that may be used by an evaluation engine. In this illustration, these additional criteria include a data state field 610 that indicates the state in which a received instance of data needs to be to meet the criteria (e.g., new, edited, deleted, viewed, printed, etc.) and to, thus, “fire” or generate a conclusion. In this illustration, the instance of data needs to be in an edited state. The criteria may be further characterized by a Boolean expression having one or more clauses that may be entered by a user, wherein the Boolean expression would need to be satisfied to fire a conclusion.

In this instance, the user was prompted with respect to several fields and correspondingly entered data (e.g., lines 622-636) to generate such a Boolean expression having several clauses. The Boolean expression clauses may be characterized by: a clause type 622 (e.g., logical); a clause junctor 624 (e.g., AND, OR); a comparison type 626 (e.g., a number, a date, a letter) that designates what is being compared; a left operand type 628 that is located on the left side of a logical operator and that may be a field (e.g., 630 Arrestees/Age) or a custom value; the logical operator 632 (e.g., <, >, =); and a right operand type 634 that is located on the right side of the logical operator and that may be a field or a custom value (e.g., 18). In this illustration, the Boolean expression entered by the user includes clauses: document is edited AND <Arrestees/Age> Less Than 18.

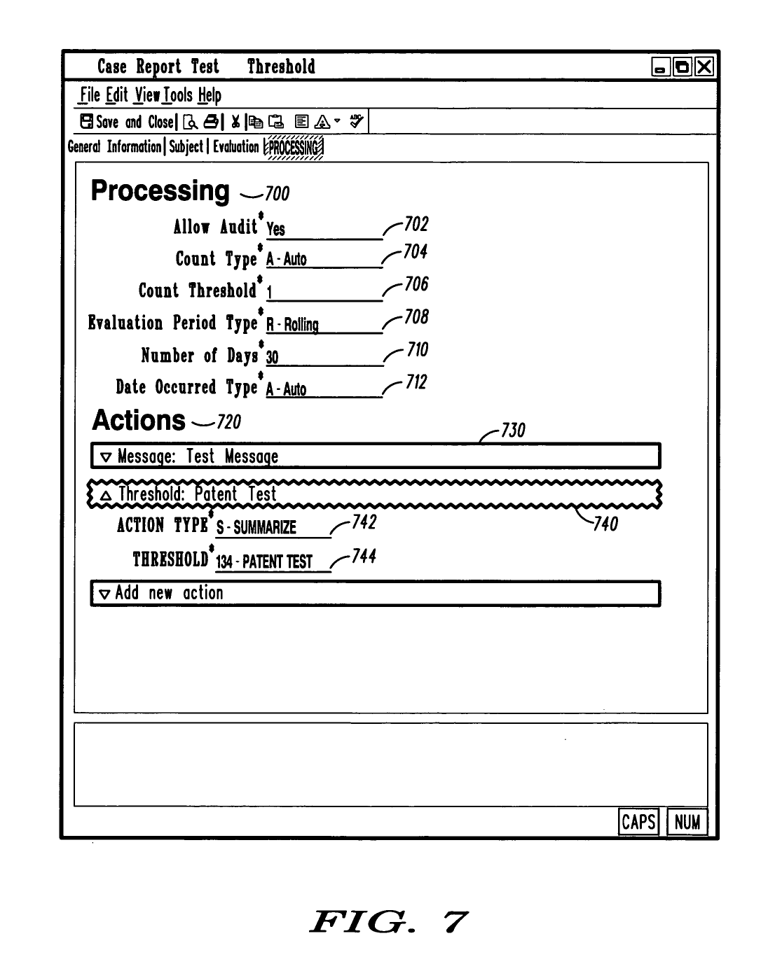

In the screen shot shown in FIG. 7, the user may be prompted to enter additional processing instructions or criteria 700 and actions instructions 720 to be used by the system (e.g., the server computer 104) upon the criteria being met and, ideally, a resultant conclusion being generated. For example, an evaluation period may be designated, which may be, for instance, always, a specific period of time (e.g., having a start date and an end date) and a rolling period of time for a designated number of days. An audit element may be designated, e.g., by setting a Boolean flag, that enables an auditing function to keep track of when and how often a conclusion fires (or is generated) for a given definition. The user interface may also prompt the user to input data regarding a count threshold that must be met for a conclusion to fire. For example, the user may indicate a threshold number of instances (e.g., an action number) that an instance of data is received and the criteria met before an action is taken. Moreover, the user may designate a field to be monitored wherein the values in the field are summed, e.g., over a plurality of instances of data, and the sum compared to a threshold set by the user.

In this screen shot, the user is prompted through the Allow Audit field 702 to designate whether or not an audit will be performed for this definition. The user is also prompted through the Count Type 704 and Count Threshold 706 fields to respectively designate when to consider an instance of data for evaluation using the definition and how often the criteria of the definition must be met before action is taken on the conclusion. If the Count Type 704 field is set to “Field,” the data in the specified field across all document instances (e.g., instances of data) in a summary within an evaluation period may be summed and compared to the Count Threshold 706 field to determine if the conclusion should be acted on. If the Count Type 704 field is set to “Auto,” the total number of document instances in the summary within the evaluation period may be compared to the Count Threshold 706 field to determine if the conclusion should be acted on.

The user is prompted through the Evaluation Period Type 708 and Number of Days 710 fields to designate the evaluation period for the definition. Finally, the user is prompted through the Date Occurred Type 712 to designate how the occurrence date for an instance of data corresponding to the definition will be tracked, e.g., automatically based upon the date the instance of data is received or based upon a field in the instance of data. In this illustration, the user has designated: to enable the audit element (e.g., Audit Allow-Yes); to count each instance of data for evaluation purposes or to evaluate each instance of data that is received (e.g., Count Type-A-Auto); to have a conclusion generated if criteria is met once within a thirty day rolling period (e.g. Count Threshold-1, Evaluation Period Type-R-Rolling, Number of Days—30); and that the date of the instance of data is when it is received (e.g., Date Occurred Type-A-Auto).

In the action instructions 720, a user can designate one or more actions to be taken with respect to a conclusion when the criteria including the processing parameters of a definition are met. An action may include, but is not limited to, sending a message, implementing a workflow engine, and/or sending the corresponding conclusion to the evaluation engine (e.g., for cascading conclusions). When a message action is designated, the user may be further prompted to input a custom message, select a message type task or notification, select a due date, and designate to whom the message should be sent, e.g., to one or more individuals, organizations or compatible processes. When a workflow action is designated, the user may be further prompted to input a workflow path that should be taken from a list of available defined workflows, for example by designating a workflow ID. When a definition summary is selected, the user may be further prompted to identify one or more corresponding additional definitions to be used in evaluating the conclusion generated based on the current definition.

In this illustration, the user has selected to send a message (e.g., Test Message) as an action. In an embodiment, the user may click on the message bar 730 to see details regarding the message including, for instance, to whom the message is sent and the content of the message. The user has further selected to send each conclusion generated for this definition to the evaluation engine as an action. By clicking on the Threshold bar 740, it can be seen that the user was prompted to select an Action Type 742 and selected Summarize to evaluate the conclusion, and was further prompted to select a definition to use in evaluating the conclusion. For example, the user has selected a definition (e.g., Patent Test) to use in evaluating the conclusion generated from the present definition.

It should be understood by those skilled in the art that the fields that are seen by the user may depend upon the previous designation(s) made by the user, thereby making the user interface adaptive. For instance, if the user had selected that the evaluation period be for a period of time, the user may have been further prompted to enter the beginning and end dates of the period of time by either entering custom dates or selecting dates from one or more fields in the instance of data. It should be further realized that the user interface may incorporate one or more drop down menus to facilitate the user's selections. Moreover, each conclusion generated may be stored in, for example, database 114 for further retrieval and processing.

Returning now to the detailed description of FIG. 3, an instance of data may be received into the system, at step 320. In one embodiment, the instance of data has a predetermined format that is usually the same or a similar predetermined format as the source documents and the definition(s) corresponding to the instance of data (e.g., an XML document). Receiving the instance of data in a predetermined format facilitates being able to receive and evaluate data that were generated from different sources, using different underlying source code and that is stored in different types of data storage means, and regardless of the data values. The instance of data also typically comprises a unique identifier, for instance, to enable the instance of data (and likewise definitions and conclusions corresponding to the instance of data) to be identified without having to store the actual data from the instance of data. Moreover, in one embodiment, the instance of data is sent to the evaluation engine via a Simple Object Access Protocol (SOAP) standard.

The instance of data may be, for instance, a completed document such as a police report, case report, etc. Typically, an instance of data will be received into the system based upon the status of the instance of data, e.g., it will be received into the system when it is created, edited, printed, etc. The instance of data may be, for instance, received from one of a number of client computers in a given group, agency or organization (e.g., client computers 106, 108, 110) or from a third party client computer (e.g., client computer 112).

Once received, the system will typically include a methodology for determining whether the instance of data will be routed to an evaluation engine, as is indicated at step 325. The methodology may comprise sending all instances of data immediately to the evaluation engine. It may further comprise a suitable means of queuing the instance of data to be received into the evaluation engine. Moreover, the methodology may determine if the instance of data should even be sent to the evaluation engine at all.

An instance of data (a received document) is evaluated, as indicated in step 330, using the definitions created in steps 310, 315. The evaluation engine ideally uses an external interface that is system agnostic in that it is not dependent on a particular type of operating system or underlying code being used. For example, the evaluation engine may comprise an XML Web service as an external interface so that it can use the XML of a definition to evaluate the instance of data that was sent. The engine retrieves all definitions for the document then may one by one read the XML from each definition. It may then use the XML to find the pertinent fields in the document and start evaluation by comparing the fields to values found in the definition or other fields in the received document. The actual state of the instance of data may also be used in evaluation. Thus the received instance of data may include its current state, e.g., the document is being printed, created, viewed, edited, etc.

The evaluation engine may generate one or more conclusions of its findings based upon the instance of data and the definition, at step 335, wherein each conclusion indicates that the criteria from a corresponding definition were met. A conclusion may comprise a summary document that is either created in a first instance or that already exists and is accordingly updated. In one embodiment, each summary (or conclusion) is also an XML document and may be stored in database 114 or, for instance, as a text file on a hard drive. Thus, no database engine is required nor is a particular database structure required. Moreover, since data is not being stored, no data mapping is needed when evaluating data across different systems. It should also be noted that a summary is not a restating or a reformatting of the data included in the instance of data. The summary instead indicates that criteria in the definition have been met regardless of the particular data values. There can be multiple summaries created based upon the defined subject for the data instance and how many subjects exist in the document. For instance, the engine may determine that an instance of data contains sensitive data on three of the four subjects found therein. These summaries may be updated as data changes and can include multiple documents (instances of data) or can be a partial sub set of an instance of data.

In one embodiment, actions are not processed by the evaluation engine but by a separate process that monitors the summaries and only acts upon the summaries not the actual data. Accordingly, this monitoring service, as indicated at 340, retrieves all summaries that have been updated since it last checked, at step 345. These summaries are reviewed to see if action is needed and then the action is performed if needed. Actions may include: implementing a workflow engine and corresponding workflow actions and tasks (steps 350, 365); implementing a messaging engine (355, 370); and/or a summary being sent back to the evaluation engine to be re-evaluated. The summary will be evaluated by a definition for that summary which in effect allows for the evaluation of prior evaluations or conclusions (e.g., cascading evaluations or conclusions).

A summary may be updated by the monitoring service, including updating the summary with all actions taken. Moreover, when the instance data is changed in a way that it no longer meets the definition the monitoring engine will be aware of the changes and may react accordingly, for instance, by correcting a corresponding earlier conclusion. This is because conclusions are not fired based upon the data, and so the system may be more readily configured to keep track of when a conclusion fired and correct the conclusion if the data in a document changes.

In one exemplary implementation, as an instance of data is created, updated, deleted, etc., an XML copy of the instance will be sent to the evaluation engine. The evaluation engine will retrieve all definitions for the instance of data and perform all necessary evaluations. From its evaluations, it may use the subject, source, and evaluation to update a conclusion table. The conclusion table may contain, for example, source, definition, subject, data (XML), and last update. Both true (criteria met) and not true (criteria not met) evaluations will be examined, but only true evaluations create conclusion records. When an evaluation is false, the conclusion table may be checked to see if a source instance exists and will update the record accordingly. The data (XML) field may contain all evaluations for each instance that have the same subject, source and definition. Thus, multiple instances of the same source may be stored in the same record, which can be used to determine count and transactional information. Also, where the count type and/or date type fields of a definition are set to “field,” the field values from a document instance may be saved in the conclusion record to be used by the monitoring engine to determine whether an action should be taken. Moreover, the last update field may be set each time a conclusion record is created or updated.

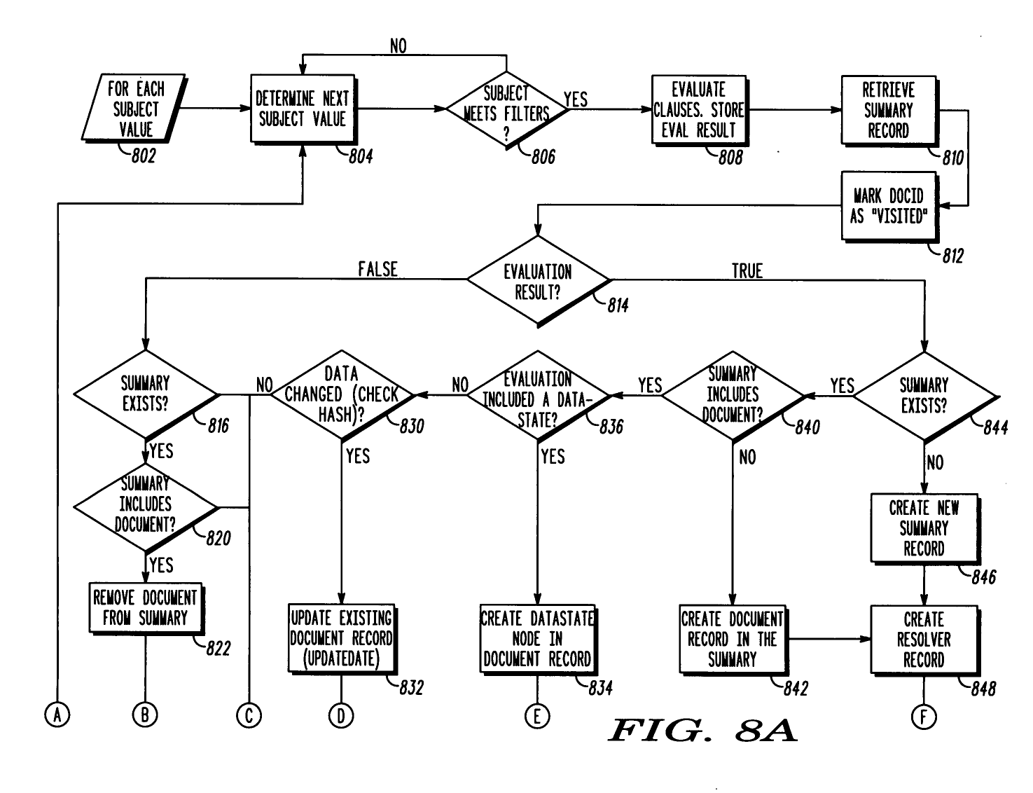

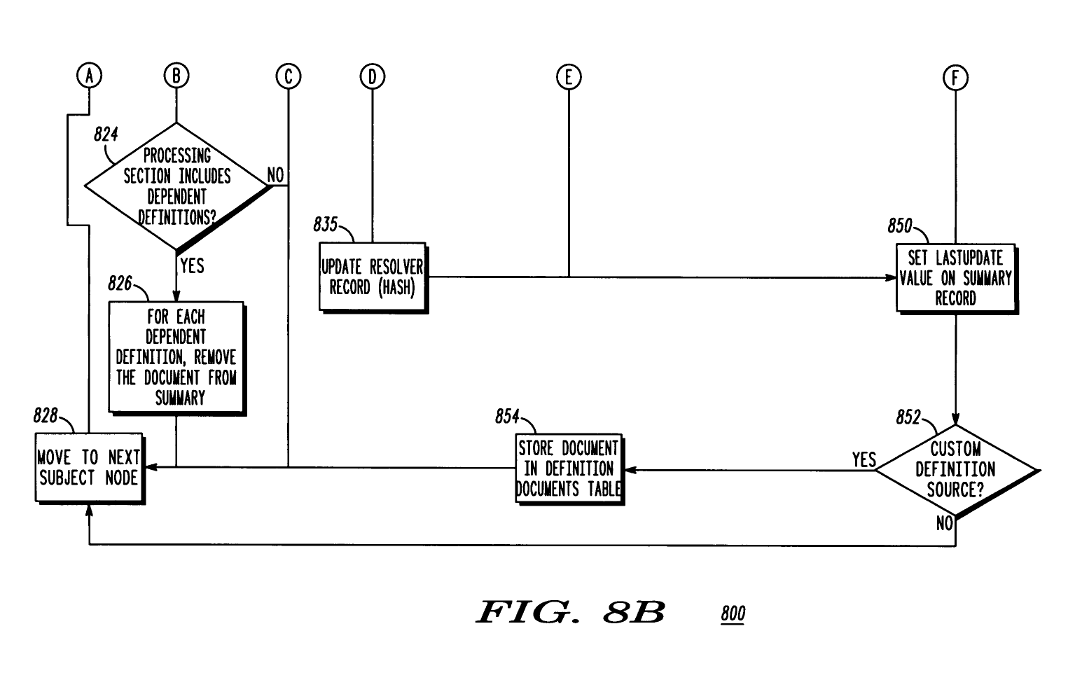

Turning now to FIGS. 8A and 8B, a detailed flow diagram of an exemplary evaluation engine that may be used in implementing the method illustrated in FIG. 3 is shown and generally indicated at 800. The evaluation engine starts processing when a document is sent into the system, e.g., from an outside source. The engine may determine which definitions to evaluate based on the source type of the document. For each definition it finds, it may determine the subject value(s) for this document. Each subject value (802) may then be evaluated according to the following steps. First, determine if the subject meets the supplied filters (806). If there are no filters defined or the subject value meets one of the filter values, then proceed evaluating the subject (808), otherwise, skip past the evaluation and move on to the next subject (804). The engine may then analyze the evaluation section of the definition to determine if a summary should be generated for this document (808, 810, 812). The engine may use the supplied XML data to determine if this document meets the threshold criteria.

If the evaluation result (814) is false, then the system may determine if there was an existing summary for this document (816). If there was an existing summary that includes this document, the engine will remove the document from the summary (820, 822). If there are any cascading thresholds, the data in each one of them will also be updated (824, 826). If the evaluation is true, the engine first determines if a summary already exists (844). If no summary exists, a new one may be created (846). A resolver record may be created (848) and may be used to track multiple subjects within a document, and may include a hash value of the data. If a summary exists, the engine may check to determine if the summary already includes the document (840). If the summary does not include the document, a new record for the document may be created in the summary, and a resolver record may be created (842, 848).

In this illustration, a resolver record is used to record which subject in a document corresponds to which summary record. The system then has the means to remove a document from all summary records where it is contained if a document is deleted or modified. For example, an instance of data (e.g., a case report (CR)) is retrieved that contains four victims, and a definition is retrieved with a subject=Victim/Name. In this case, the system might typically generate four separate summaries, one for each victim. If the CR document is then edited to remove one of the victims from the CR, the system needs a method to update any previous summary records based on the CR. As the evaluation engine reviews the edited CR document, it will observe the three existing victims and mark those subjects as visited. It may then read all of the resolver records that were written for this document and determines that three of the victims still exist, but the fourth victim is missing. The evaluation engine may then update that particular summary, and remove the reference to this CR document (and also cleanup the resolver record).

The resolver record may include a hash value (e.g., a pseudo-unique value based on the input data) of the data as it was last saved. The system can use this information to determine if any of the existing three victims need their summaries updated. Hash values are generated using a suitable algorithm to output a fixed length result that is ideally unique for a given set of data, regardless of the data input size. A change in even a single character can result in a different hash result. Hash values are used to validate passwords, handle digital signatures, etc. Some examples of available hash algorithms are MD5 and SHA1, as is well known in the art.

If the document does already exist in the summary, the engine may check to see if the evaluation process includes a data state evaluation (836). If there is a data state evaluation, the engine may create a data state node within the document record (834). Otherwise, the engine may verify that the data in the document has been changed (using the resolver record and a stored hash value) (830). If the data is not changed, it may move on to the next record (828). If the data has been changed, the existing document record in the summary may be updated, as well as the resolver record (832, 835). If the summary record was updated in any way, a LastUpdate value in the summary record, for example, may be reset so that the monitoring service or engine may pick up the change on the next iteration (850). If the definition corresponds to a custom source, the engine might store a copy of the document data (852, 854). The engine can then move on to the next subject (828). Once all subjects in the document have been evaluated, the evaluation engine can evaluate the next definition.

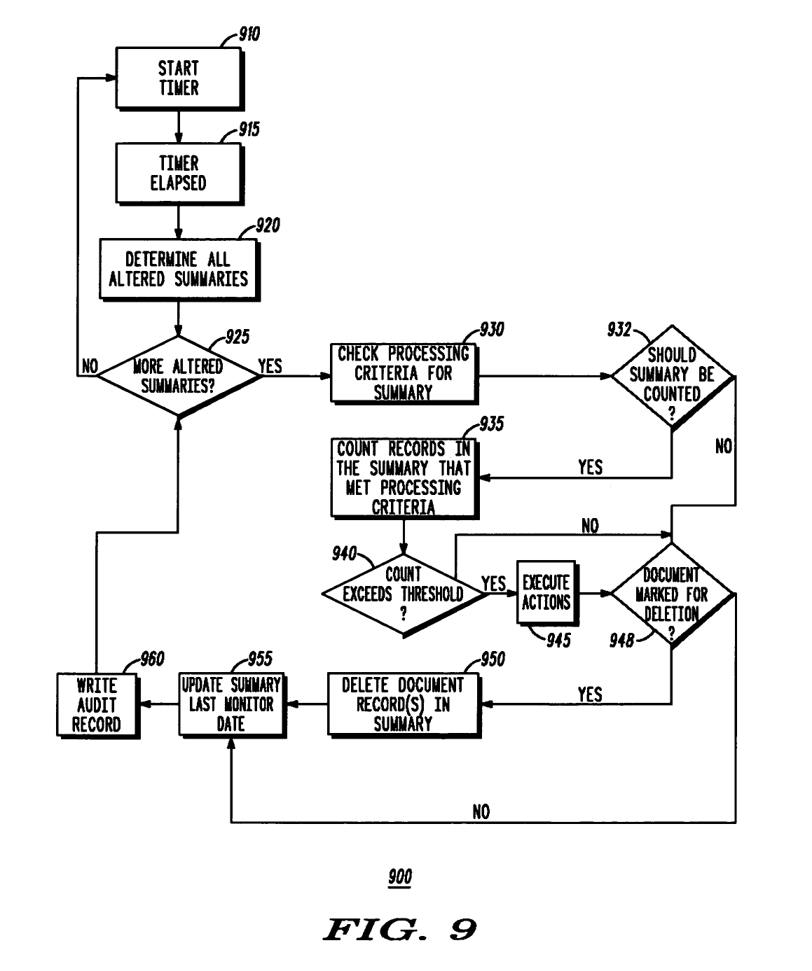

Turning now to FIG. 9, a detailed flow diagram of an exemplary monitoring service or engine that may be used in implementing the method illustrated in FIG. 3 is shown and generally indicated at 900. The monitoring service may install and run as a windows service. It typically has a timer that is running in the background, and ideally at a configurable interval, it may start the monitoring process (910). When the timer elapses (915), the monitoring service may search the list of summary records for any summary that has been altered since the last time the monitoring service ran (920, 925). For each altered summary record, the processing criteria for the corresponding definition may be examined, and the monitoring service may determine if action needs to be taken (930). The monitoring service may use the processing period and count criteria to determine if the summaries exceed a threshold level (932, 935, 940).

If action is to be taken, the monitoring service may examine all document links in the summary and take appropriate action (945). Examples of possible actions are: send a message with links to all the summarized documents, create a task, submit the related documents to workflow or re-submit the data to the evaluation engine for further evaluation. Once the summary record has been analyzed, the monitoring service may check to see if the record has been marked for deletion (948). If it has, the summary record will be cleaned up (950). The cleanup is done at this stage so that definitions can be fired on a deleted action. The monitoring service may further update the last monitor date of the summary (955).

The monitoring service may write an audit record (960) if, for instance, either the audit flag in the definition is enabled or an error occurred during the monitoring process. If an error occurred, a custom XML request may be sent to the evaluation engine, allowing definitions to fire based on submission errors. The monitoring service can now process the next record that has been altered since the last summarization (925). Once all records are processed, the monitor can restart the timer (910) and wait for it to elapse (915).

Following is a description of an exemplary case scenario that demonstrates a particular implementation of and illustrates some of the advantages of various embodiments of the present invention. This case scenario is not meant to limit the principles of the invention in any way but is meant to assist in understanding the principles of the invention.

In this case scenario, a police agency would like to react to any area that has a high level of gang related activity. The agency may search for any document types that contain gang related activity. After each document type that can contain gang related activity is identified, a definition can be created. Each document type may have its own unique definition. The definition could include the location defined as the subject. The definition evaluation section can have the logic used to determine if a completed document includes activity that is gang related. The action section of the definition can have an evaluation period defined and a threshold for that period that defines the “high” level of activity. It may further include a way of determining when the activity took place and an action to notify the gang task force.

Once this definition is created, all completed documents of this type can be sent to the evaluation engine. The evaluation engine may then retrieve the document definition for gang related activity. It can determine the subject of the completed document. It can then evaluate the completed document to determine if it meets the definition of gang related crime. If the definition is met, the evaluation engine may then look to see if the subject has a summary already created. If it does not it can create a new one, and if it does it can update the summary.

The summary may typically include the conclusions found for the completed document, a unique number for the completed document, and the date of occurrence for the completed document. This summary may be saved with the current date and time. The monitoring service can use this date to determine that the summary has changed since it last checked, and can retrieve the summary and use the definition to determine if the actions should occur. The monitoring service may review the summary and see if the threshold amount within the specified time period is met. If these criteria are met the monitoring service may send off a message to the gang task force. This message may include, for instance, the conclusion and a reference back to the documents and their document type.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for rules-based data evaluation and process trigger executed in a records management system that includes a server computer and at least one client computer, the method comprising the steps of:
receiving a source document having a predetermined format;
creating at least one definition for the source document, each definition comprising at least one criterion for evaluating an instance of data corresponding to the source document;
receiving a first instance of data corresponding to the source document;
evaluating the first instance of data using the at least one definition and determining whether to generate at least one conclusion based on the evaluation, each conclusion indicating that the at least one criterion is met; and
determining whether to perform at least one action based on at least one generated conclusion.

2. The method of claim 1, wherein each definition further comprises at least one action to be performed based on a result of evaluating an instance of data corresponding to the source document.

3. The method of claim 2 further comprising the steps of:
generating at least one conclusion based on a definition; and
performing the at least one action in the definition.

4. The method of claim 3, wherein the step of generating at least one conclusion based on the definition comprises at least one of creating a summary document and updating a summary document.

5. The method of claim 4, wherein the summary document comprises an Extensible Markup Language document.

6. The method of claim 2, wherein the at least one action comprises at least one of: sending a message, sending a conclusion to a workflow engine and sending a conclusion to an evaluation engine.

7. The method of claim 2, wherein each definition further comprises at least one of an evaluation period that must be satisfied before performing the at least one action in the definition and a count threshold that must be met before performing the at least one action in the definition.

8. The method of claim 2, wherein each definition further comprises at least one of a name, a subject, a unique identifier for the source document corresponding to the definition and an identifier for a group.

9. The method of claim 8, wherein each definition corresponds to a single subject.

10. The method of claim 1, wherein the predetermined format is Extensible Markup Language (XML), and the source document comprises an XML schema for data in the source document.

11. The method of claim 1. wherein the at least one definition is an Extensible Markup Language (XML) document, and the first instance of data is an XML document.

12. The method of claim 1, wherein the at least one criterion comprises a Boolean expression.

13. The method of claim 12, wherein the Boolean expression comprises a data state clause that enables an instance of data to be evaluated based on the state of the instance of data.

14. The method of claim 1, wherein the first instance of data is received using a Simple Object Access Protocol (SOAP) standard.

15. A device operatively configured for:
receiving a source document having a predetermined format;
creating at least one definition for the source document, each definition comprising at least one criterion for evaluating an instance of data corresponding to the source document;
receiving a first instance of data corresponding to the source document;
evaluating the first instance of data using the at least one definition and determining whether to generate at least one conclusion based on the evaluation, each conclusion indicating that the at least one criterion is met; and
determining whether to perform at least one action based on at least one generated conclusion.

16. A device in accordance with claim 15, wherein the device comprises an evaluation engine for evaluating the first instance of data using the at least one definition and determining whether to generate at least one conclusion based on the evaluation, wherein the evaluation engine comprises an Extensible Markup Language Web service.

17. A device in accordance with claim 16, wherein the device further comprises a monitoring engine for monitoring each conclusion generated by the evaluation engine and determining whether to perform at least one action based on each generated conclusion.

18. A device in accordance with claim 15, wherein the device comprises a user interface for creating the at least one definition for the source document.

19. A device in accordance with claim 18, wherein the user interface is adaptive based on at least one input by a user, and the user interface comprises at least one drop down menu for a user to select a field corresponding to a field in an Extensible Markup Language document.

20. A system comprising:
at least one server computer configured for:
receiving a source document having a predetermined format;
creating at least one definition for the source document, each definition comprising at least one criterion for evaluating an instance of data corresponding to the source document;
receiving a first instance of data corresponding to the source document;
evaluating the first instance of data using the at least one definition and determining whether to generate at least one conclusion based on the evaluation, each conclusion indicating that the at least one criterion is met; and
determining whether to perform at least one action based on at least one generated conclusion; and
at least one client computer operatively coupled to the at least one server computer via a network, each client computer configured for generating an instance of data and transmitting it to the at least one server computer.
